(19) United States
(12) Patent Application Publication
(10) Pub. No.: US 2026/0233900 A1
(43) Pub. Date: Aug. 13, 2026

(54) ENERGIZABLE WRAP APPARATUS AND METHOD FOR EXTRACTING LIQUID FROM CONTAINERS

(71) Applicant: J. Nicholas and Kristin Gross Trust U/A/D April 13, 2010, Berkeley, CA (US)

(72) Inventor: John N Gross, Berkeley, CA (US)

(21) Appl. No.: 19/349,989

(22) Filed: Oct. 4, 2025

Related U.S. Application Data
(60) Provisional application No. 63/703,204, filed on Oct. 4, 2024.

(51) Int. Cl. B65D 35/28; B01F 31/20; B67D 3/00

(52) U.S. Cl. CPC B65D 35/28; B01F 31/28; B67D 3/0012; B67D 3/0022; B67D 3/0061; B67D 3/0077; B67D 2210/00102; B67D 2210/00163

(57) ABSTRACT

An apparatus and method adapted to remove liquids from containers is disclosed, with active energy delivery elements designed to dislodge and cause movement of the material within the container using vibrational energy to overcome viscosity. The apparatus includes a vibrational wrap type structure that is configured to hold, position, and deliver vibrational energy to a container in an efficient manner and shake loose hard to remove material collected in the container. Additional heating elements can be employed to reduce viscosity and improve flow as well. During an activation mode, electrical energy can be used to power the vibration elements such that controlled and continuous removal of material can be achieved.

### RELATED APPLICATION DATA

The present application claims the benefit under 35 U.S.C. 119(e) of the priority date of Provisional Application Ser. No. 63/703,204 filed Oct. 4 2024 which is hereby incorporated by reference.

### FIELD OF THE INVENTION

The present invention generally relates to the field(s) of fluid extraction technology from containers. More specifically, embodiments of the present invention pertain to a glove or wrap apparatus and method for helping remove food items, cosmetic items, toiletry items, and similar household liquids from small bottles having different compositions using vibrational and/or heat energy.

### BACKGROUND OF THE INVENTION

Liquid-based products are distributed in multiple container forms as seen in FIG. 10A, which depicts a number of shapes and sizes for contemporary materials, ranging from shampoo (a cleaning liquid) to ketchup (a food condiment liquid). It will be understood that other liquids/containers are available in commerce and that this is merely a cross section of some common forms.

A common problem that arises with liquids is depicted in FIG. 10B. In particular, the viscosity of fluids changes (i.e., typically, increases) over time due to multiple different factors, including temperature, gravity, water loss, etc., which makes it more difficult to remove them from such containers as they do not flow easily from such articles. The viscosities (at nominal room temperature) of a number of common liquids are shown in FIG. 10D, and as can be seen, ranges by a factor of more than a 1000.

The problem of dispensing fluids is exacerbated when the containers are refrigerated (as is a common requirement for certain foods) as this typically increases viscosity and reduces ease of flow as shown in the chart of FIG. 10E in the example of ketchup. Over time, as seen in FIG. 7D, material migrates to the bottom of the container where it becomes condensed, thicker, etc. As seen in FIG. 10B, a typical container 170 (which may be cylindrical, rectangular, etc.) with sidewalls 172 storing liquid 180 may be stored in an upright position (i.e., with a first side 171 on the bottom and a sealable cap situated on top of a second side 173). To extract the fluid 180, which may have a high viscosity because the material is cold, and has become condensed and thicker, a consumer is typically required to flip container 170 and then manually tap or apply an impulse to bottom surface 171 to break the surface tension and induce flow along the interior sidewalls 172 as depicted by the green arrow in FIG. 10B. Over time and with repeated manual force, the fluid 180 moves along the sidewalls and the consumer can (ideally) force at least some of it into or in a region near cap 174 so that it can be dispensed by tapping, squeezing, etc. Even using this approach, it is extremely difficult to remove all the material from the sidewalls.

Another trick that is sometimes employed is that consumers will invert container 170 and simply rely on gravity, time, and shearing forces to achieve some measure of flow. Note that it is not always desirable or possible to store container 170 in this inverted position as there is frequently leakage of liquid 180 resulting in loss of material and messy cleanup work. Moreover, some containers have irregular shaped caps or tops and cannot be balanced securely in an upside-down position.

The prior art manual and/or passive techniques therefore are known to be imperfect, and frequently it is the case that consumers are not able to extract a particular liquid within a reasonable time (or in any amount of time) after they access it for a particular purpose. Even after the material 180 is moved within the container, it can be difficult to control as a result of it immediately dumping in undesired amounts after the cap 174 is removed.

In addition, containerized liquid-based products are commonly discarded with useable contents remaining inside. This undesired outcome regularly occurs after a consumer, through exhaustion of efforts in timely and reasonable container handling and movement (as discussed above), is no longer able to expel any more of the contents and results in material being wasted and, thus, possible frustration is experienced by the end user over the diminishment of the product's utility.

Product manufacturers attempt to mitigate this problem by designing containers in ways that increase evacuative influences. For example, the famous Heinz Ketchup bottle includes instructions to consumers to tap it at a specific embossed spot identified as “57” on the sidewall. As seen in FIG. 10C, other attempts to maximize the amount of extrapolation of materials from a container involve fitted attachments 172 or augmentation, including as taught in U.S. Pat. No. 755,627 incorporated by reference herein. Such designs and additions are limited in their ability to impose a broad influence on the widely varying content compositions and container sizes. This leads to an unfulfilled need for a more indiscriminate solution.

Other art in the liquid container field includes: U.S. Pat. No. 9,967,924, which illustrates a radio frequency (RF)/induction heater for fluids; U.S. Pat. No. 5,794,904 and U.S. Pat. No. 435,711, which describe inverted bottle holders; U.S. Pat. No. 5,080,150, which shows a passive bottle draining basket; US Pub. No. 2010/0314418 and U.S. Pat. No. 10,131,473, which describe improved dispensers; US Pub. No. 2014/0332477, which describes a funnel; US Pub. No. 2012/0305598 and U.S. Pat. No. 6,684,922, which describe passive draining devices; and US RE37,566, which describes a flexible holding device, all of which are hereby incorporated by reference.

None of these innovations, however, provide a satisfactory solution to the problems above.

Consequently, there is a long felt need for improved devices and methods for extracting liquid from containers beyond the solutions offered to date, to reduce waste, time, and consumer frustration. This “Discussion of the Background” section is provided for background information only. The statements in this “Discussion of the Background” are not an admission that any particular subject matter disclosed in this “Discussion of the Background” section constitutes prior art to the present disclosure and, except for those portions specifically identified as prior art, no part of this “Discussion of the Background” section may be used as an admission that any part of this application, including this “Discussion of the Background” section, constitutes prior art to the present disclosure.

### SUMMARY OF THE INVENTION

An aspect of the present disclosure therefore is to provide systems and methods, which address the limitations in the prior art noted above.

A first aspect of the disclosure pertains to an apparatus (and associated method) that facilitates movement and flow of a liquid material in a container to make it more easily and quickly dispensable compared to prior art techniques.

A second aspect of the disclosure pertains to an apparatus (and associated method) that increases an absolute amount of starting liquid material dispensed from a container.

A third aspect of the disclosure relates to an apparatus (and associated method) that increases control of liquid as it is dispensed from a container.

A fourth aspect of the disclosure relates to employing vibrational energy, heat energy, or a combination thereof, to reduce viscosity of a liquid and/or increase flow within a container to increase ease/control of material removal.

These and other aspects of the inventive embodiments are described in detail below. It will be understood and appreciated by skilled artisans that not all embodiments of the invention need incorporate all aspects as described above, and that the scope of the invention(s) herein is/are defined exclusively with reference to the claims set out below.

### DESCRIPTION OF THE DRAWINGS

FIG. 1 shows a first embodiment of a liquid extraction apparatus, which employs an energizable vibrating wrap electrically powered to facilitate removal of material from a container positioned and secured within;

FIG. 2A shows a front side exterior view of a first embodiment of a liquid extraction apparatus, which incorporates a flexible energizable wrap with embedded vibrational elements and optional heating and fastening elements to secure and automatically facilitate removal of material from a container;

FIG. 2B shows a back side exterior view of the first embodiment;

FIGS. 2C and 2D show respective side exterior views of the first embodiment;

FIG. 3 shows structural and electronic elements associated with an underlayer of the energizable wrap in the first embodiment including vibrational elements, heating elements, light emitting elements, and interconnection circuitry;

FIGS. 4A and 4B show an embodiment of an electrical control circuit and control panel, respectively, used in implementations of the described apparatuses;

FIGS. 5A-5D illustrate an example of a container being wrapped and secured by the first embodiment;

FIG. 5E shows an overhead view of the apparatus of the first embodiment with a container wrapped/secured and made ready for a liquid extraction process;

FIG. 5F shows a variant of the first embodiment in which active vibrational elements and optional bearing elements are incorporated with pocket features of the energizable wrap;

FIG. 6A shows the first embodiment of a liquid extraction apparatus in an active operational mode during which material within the container is moved from a top portion to a bottom portion;

FIG. 6B shows the first embodiment of a liquid extraction apparatus in an active operational mode during which material within the container is controllably removed and dispensed through a bottom portion;

FIG. 7A shows a structural overlay of the active elements (including vibrational and optional heating elements) of a first embodiment of a liquid extraction apparatus engaging with surfaces of the container during an activation mode to move material therein;

FIG. 7B shows the movement of material in sidewalls of the container during an activation mode;

FIG. 7C visually depicts the migration and change of position of material in a container over time as effectuated by embodiments of the disclosure, and associated changes in light detection as a result thereof;

FIG. 7D visually depicts settling of a typical material in a container as occurs naturally over time;

FIGS. 8A and 8B show an optional vibration tube and pocket that can be incorporated within the first embodiment for securing and treating smaller container items;

FIG. 9 shows an optional support structure for the first embodiment for providing rigidness to the body of the energizable wrap, and integrated container neck receptacle functionality;

FIG. 10A identifies a number of different types of containers for different types of liquid materials;

FIG. 10B identifies a conventional manual technique for extracting liquid materials from a container;

FIG. 10C identifies a number of prior art passive gravity solutions for extracting liquid materials from containers;

FIG. 10D is a list identifying the viscosity of a number of common liquids at room temperature;

FIG. 10E is a chart identifying the viscosity of a typical ketchup composition over a wide range of temperatures.

### DETAILED DESCRIPTION

Reference will now be made in detail to various embodiments of the invention, examples of which are illustrated in the accompanying drawings. While the invention will be described in conjunction with the following preferred embodiments, it will be understood that the descriptions are not intended to limit the invention to these embodiments. On the contrary, the invention is intended to cover alternatives, modifications and equivalents reasonably understood by persons of ordinary skill in the art to be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, and components have not been described in detail so as not to unnecessarily obscure aspects of the present invention. Furthermore, it should be understood that the possible permutations and combinations described herein are not meant to limit the invention. Specifically, it will be understood by those skilled in the art that variations that are not inconsistent may be mixed and matched as desired.

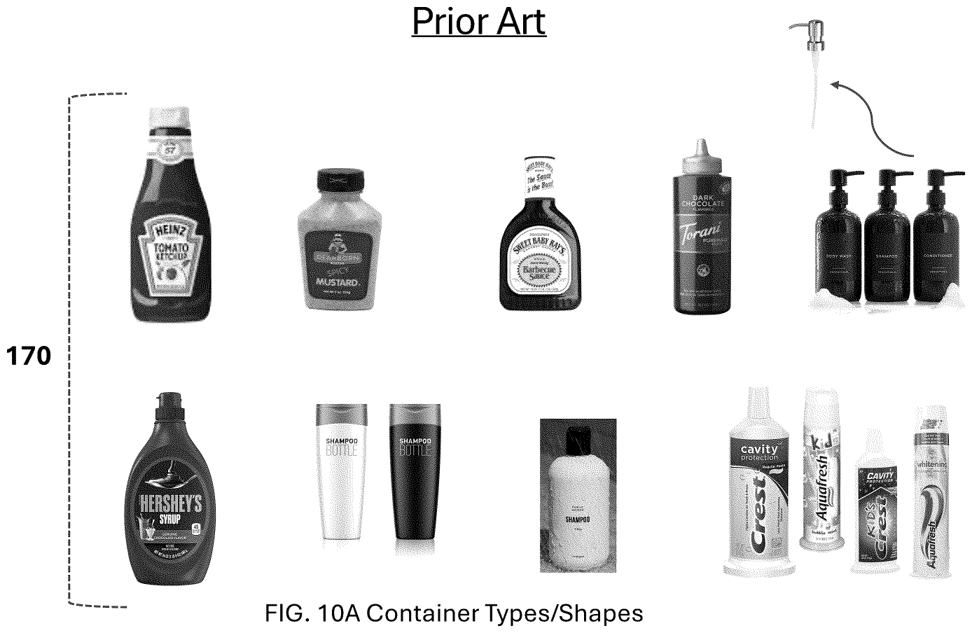

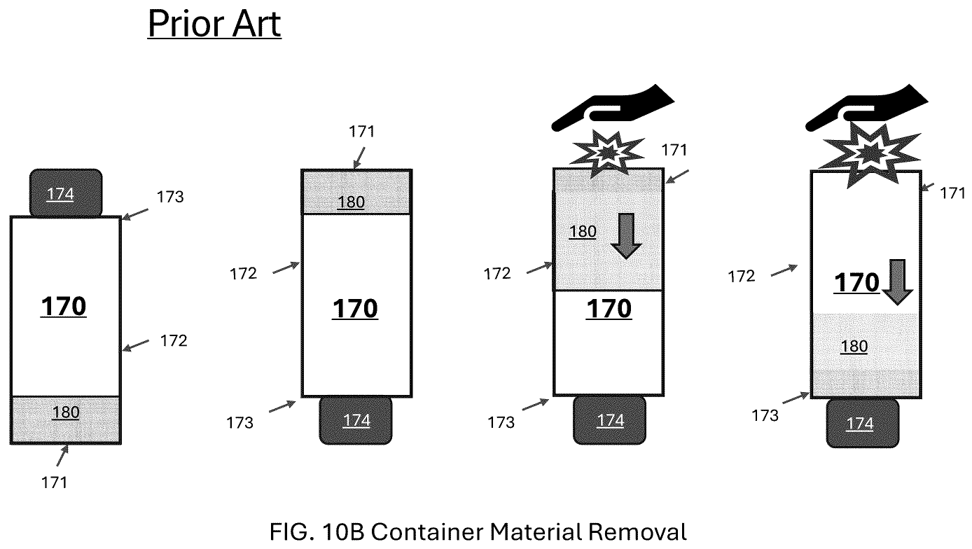

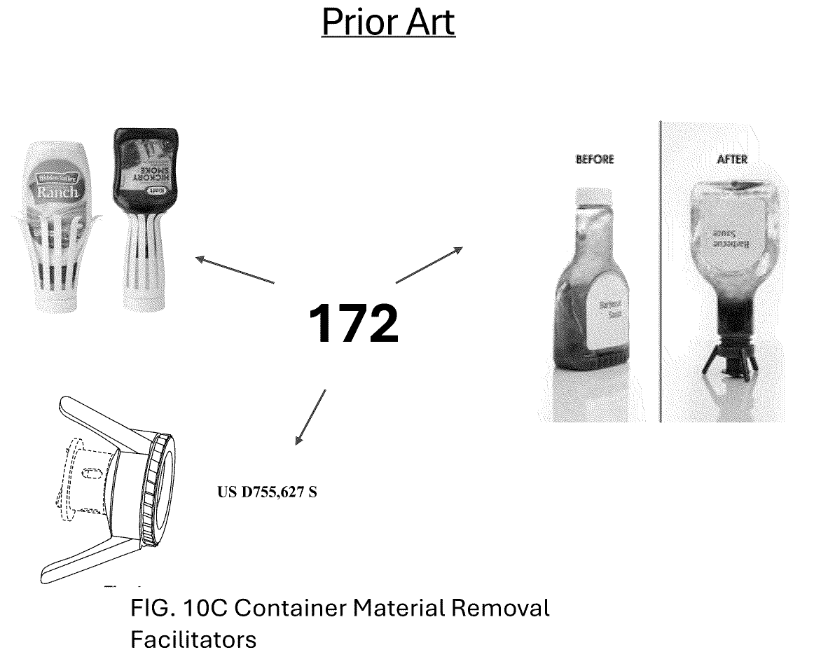

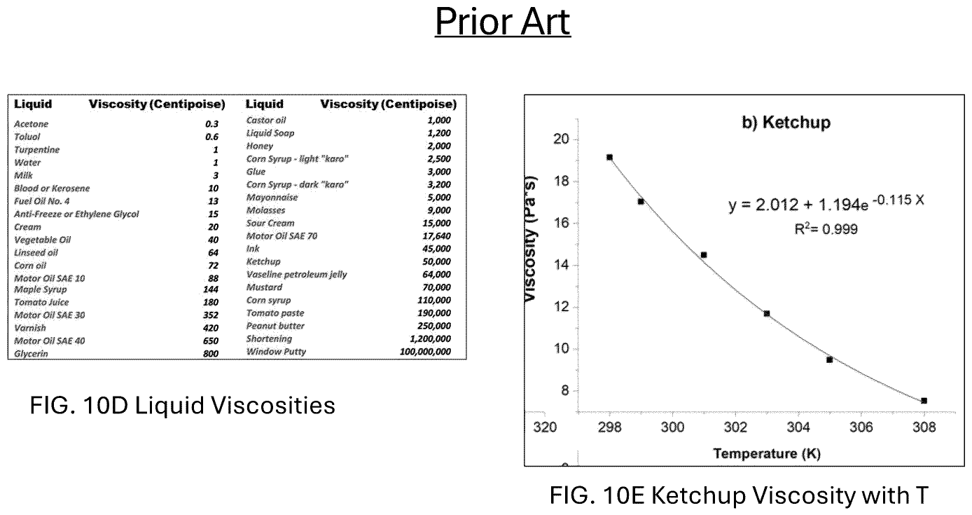

As discussed above, bottles and other containers are used for storing any number of household consumable (e.g., condiments, sauces, toppings, spreads, etc.) and non-consumable (e.g., soaps, shampoos, lotions, etc.) liquids having different viscosities. FIG. 10D shows that these liquids can have very low viscosity, like water (V=1 Centipoise) to liquids like Peanut Butter with a very high viscosity (V=250,000). The viscosity of a fluid is a measure of its resistance to deformation or flow at a given rate. Colloquially, this is referred to as “thickness,” meaning for example that typically molasses is considered “thicker” than milk, as seen in the FIG. 10D table.

The magnitude of the viscosity of a fluid directly affects how easily it flows out of a container. This is why it easier to pour water (low viscosity) out of a bottle than ketchup (high viscosity). To make a fluid flow out of a container, therefore, one can either change/reduce the viscosity of the material to make it more easily flowable and/or apply sufficient force to overcome the deformation resistance. For some fluids, as is known from direct experience, the resistance can be overcome simply by turning the bottle upside-down to cause it to move from the bottom of the bottle to the neck. This is the technique used in the prior techniques, which rely on gravity as the force to act on the liquid surface over time, or vigorous manual shaking.

Embodiments of the present invention as discussed herein use other controllable applied energy and forces—preferably, in the form of vibrational energy powered from an electrical source—to overcome the liquid viscosity beyond just passive gravity and manual shaking. Vibrational energy is provided to one or more surfaces of the container (top, bottom, sides, etc.), which has the effect of heating the material to reduce viscosity and, through such added force combined with gravitational force, is sufficient to overcome any flow resistance and cause the material to flow to the bottom of the container for easier dispensing. The amplitude and frequency of vibrational energy can be controlled easily using conventional techniques to allow for a wide range of extractions of different types of materials from any type of container.

Viscosity is affected by other influences and factors as well, including temperature. This is seen in FIG. 10E. Higher temperatures decrease the viscosity of fluids due to the increased kinetic energy of the molecules. Raising the temperature of some liquids too much, however, is undesirable as it will compromise their composition, taste, etc. Accordingly, any heating of a container to reduce viscosity preferably should be done in the smallest area, for the shortest period of time, and at a temperature that is below that which could impair the texture, taste, longevity, etc. of the material in question.

In selected embodiments of the present invention, heat energy, therefore, is also exploited to reduce viscosity selectively in areas (e.g., typically proximate to a sidewall surface) of a container. This has the effect of causing flow of the material at the interface to the sidewall, bringing about an avalanche effect with the rest of the material. This additional heat energy is preferably applied in a controllable area, for a predefined time, and at a predetermined temperature that is tailored to the container, material, etc.

Pressure also affects viscosity for some types of fluids such as ketchup, which is considered a non-Newtonian fluid because its viscosity is dependent on shear rate. When materials like ketchup are squeezed, they can be extracted faster because the viscosity decreases as it yields to pressure. This behavior is called shear thinning and is caused by polymers that are added to the liquids as a thickener. For most liquids, too, there is a certain amount of stress that needs to be overcome before they will flow. In some embodiments of the invention, the vibrational energy applied to flexible sidewalls can effectuate a limited form of “squeezing” to apply pressure in the same way to bring about the same result.

Furthermore, viscosity is also affected by changes in the composition of the material as a result of environmental factors. For liquids like ketchup, mustard, etc., water or other ingredients (like vinegar) can “leach” (separate out) and cause a portion of the mass to dry out and become more viscous; this is noticeable when a container is turned upside-down and the first material to flow is water/vinegar, etc. The most common technique to fix this, again, is to shake the container to homogenize the ingredients. Embodiments of the present invention can effectuate the same kind of viscosity reduction and increased homogenization through vibrational energy.

All reference numbers used herein correspond to the same structure in each figure unless otherwise indicated.

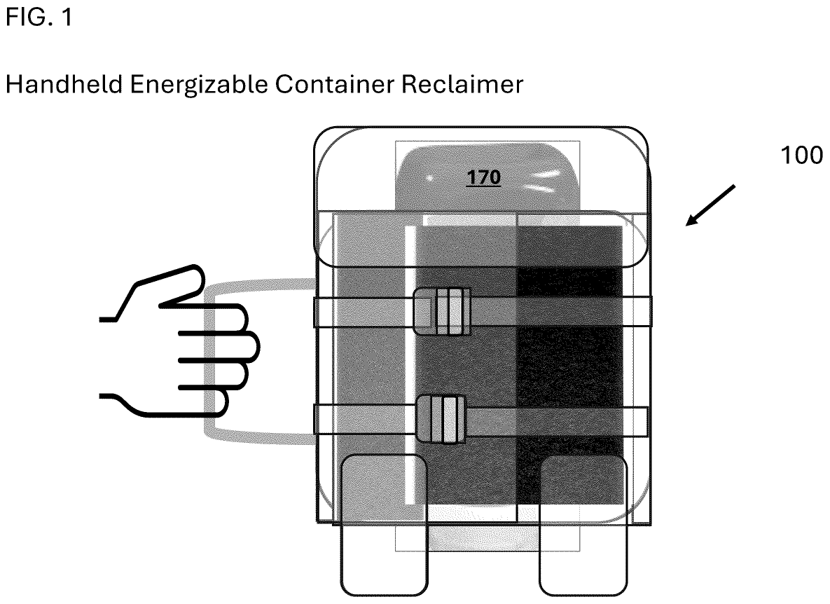

FIG. 1 shows a first embodiment of an energizable liquid extraction apparatus which employs a vibrating wrap 100 electrically powered to facilitate removal of material from a container 170 positioned and secured within. The apparatus is compact, self-contained, lightweight, and—in most instances (depending on the container weight)—can be held in a user's hand or on top of a rigid surface for support (during operation).

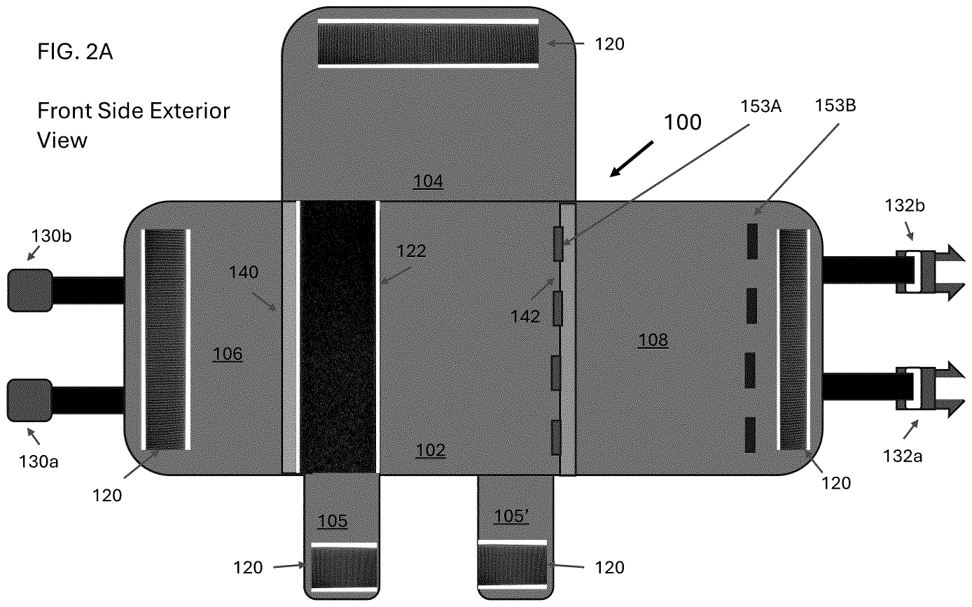

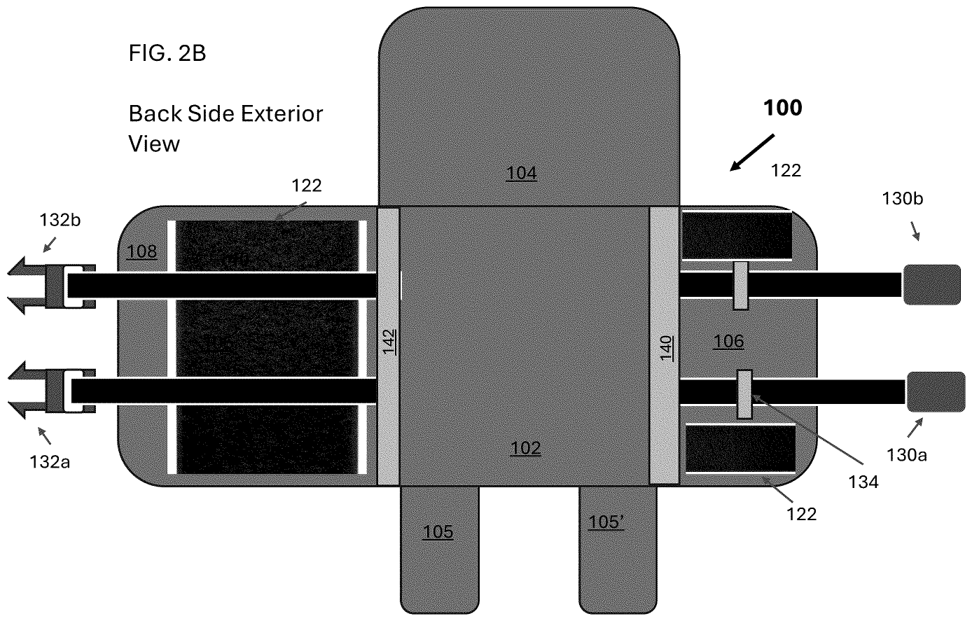

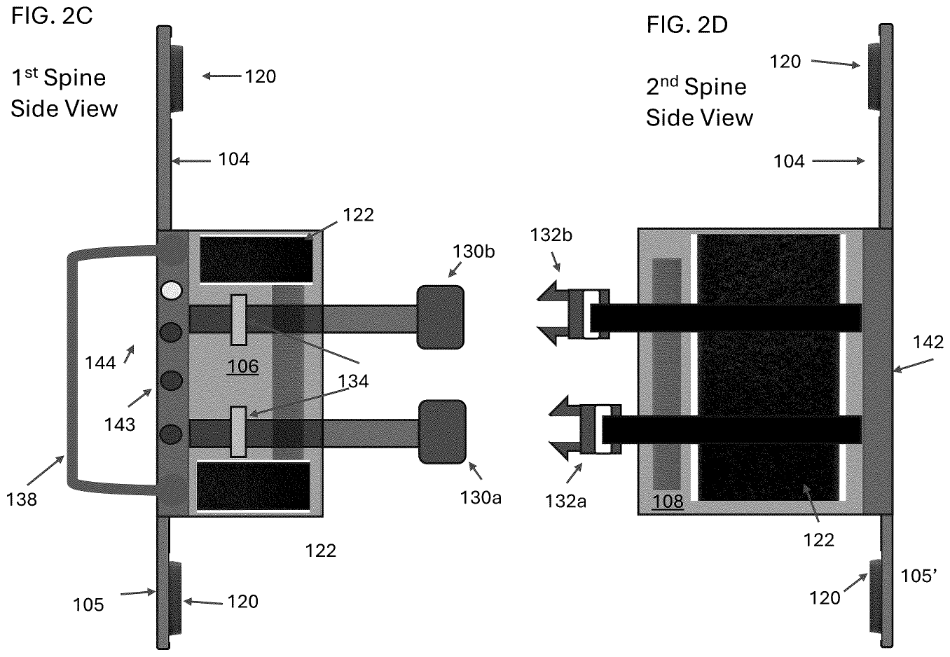

FIG. 2A shows a front side exterior view of a first embodiment of a liquid extraction apparatus which incorporates a flexible activatable vibration wrap 100 with embedded vibrational elements and optional heating and fastening elements to secure and automatically facilitate removal of material from a container. The wrap portions can be made of any suitable cloth material, including cotton, denim, synthetics, etc., and preferably has some elasticity that allows for it to stretch, allowing it to conform and secure a container shape placed therein.

The flexible activatable wrap includes a main body section 102, a top section 104, bottom tab sections 105, 105′ and foldable side/wing sections 106, 108. These are shaped, sized, and arranged to allow folding of the wrap to secure, envelop, and surround the container with activatable energy delivery elements as noted below. It will be understood from the present description that the number, arrangement, and interaction of the wrap components can be implemented through several similar satisfactory arrangements. The wrap further includes surface contact fastening elements 120, 122, which can be hook and loop structures or any other structure known in the art that are compatible with the objectives of the present teachings. These contact fastening elements, as described below, operate to secure a container 170 in both a vertical and horizontal position with the wrap, and maintain contact by the energy delivery elements to the container.

Additional clip or cinch type fastening elements 130a, 130b are attached to flat straps on one wing side 106 of the wrap, while counterpart fastening elements 132a, 132b, respectively, are attached to counterpart flat straps on wing side portion 108. These cinch type fastening elements are in the form of spring fit clips and, when slack tightened, operate to increase a contact pressure of the vibrating and heating elements in the wrap.

The wrap further preferably includes a pair of rigid spine structures 140, 142, to which the other wrap flexible sections-main body 102, top 104, wings 106/108) may be attached for additional support. Spines 140 and 142 may be constructed of any suitable material (e.g., hard plastic, thin sheet metal, etc.) and house electrical control circuity, electrical energy storage devices (e.g., batteries), etc.

Additional optional optical sensing elements 153A, 153B can be included in wrap 100, as well, in instances where it is useful or desirable to automatically detect the movement of material within the container over time (during a fluid extraction process). These elements include both a light emitting device 153B and a corresponding light detection sensor 153A at different vertical locations along spine element 142. An intensity of light from a source 153B can be detected at a sensor 153A to determine the presence and amount of liquid material in a particular horizontal plane (height) within the container, to track the movement of such material. In this instance, the controls and energy supplied to such devices 153A, 153B can be housed within the latter spine element 142.

When engaging a container, it can be seen that least a first body surface of the body portion 102 is adapted to make contact with the solid container and position vibration elements 152 in proximity to a first container surface (e.g. a backside). The foldable wing sections 106/108, which are attached or attachable to body section 102, are adapted to be positioned in proximity to and cover at least a portion of a second container surface so as to compress and force the first container surface to be in close proximity to vibration elements 152. The fastening elements 130A/132Aand 130B/132B are also attached to either or both body section 102 and the one or more flexible wing sections 106/108. These fastening elements are adapted to assist in maintaining a solid container positioned between the body section 102 the flexible wing sections 106/108.

FIG. 2B shows a back side exterior view of the fluid extraction wrap 100. The backside of wing portions 106 and 108 include additional counterpart surface contact fastening elements 122. Loops 134 constrain movement of the horizontal cloth strap members affixed to latch mechanisms 130a, 130b. Spine housing 140 is typically larger than spine 142, as the former is used to house energy storage devices (e.g., batteries), extraction control circuitry, etc.

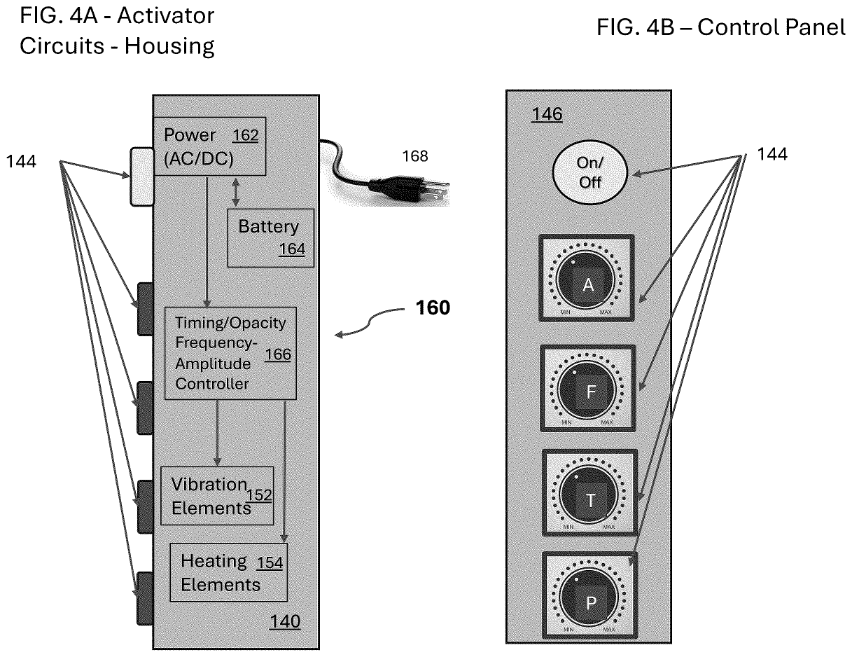

FIGS. 2C and 2D show respective side exterior views of the fluid extraction wrap 100. A handle 138 is included for ease of grip of the wrap while it is operating. The handle 138 is shown in a pivoted position here, and not an actual position, to help identify it better. A control panel 143 with multiple control knobs 144 (see e.g. FIGS. 4A and 4B) for activating and controlling the liquid movement/extraction process is preferably configured in this location of the apparatus along the sidewall of spine 140. It will be understood that the control panel can be implemented in other areas of wrap 100 as well.

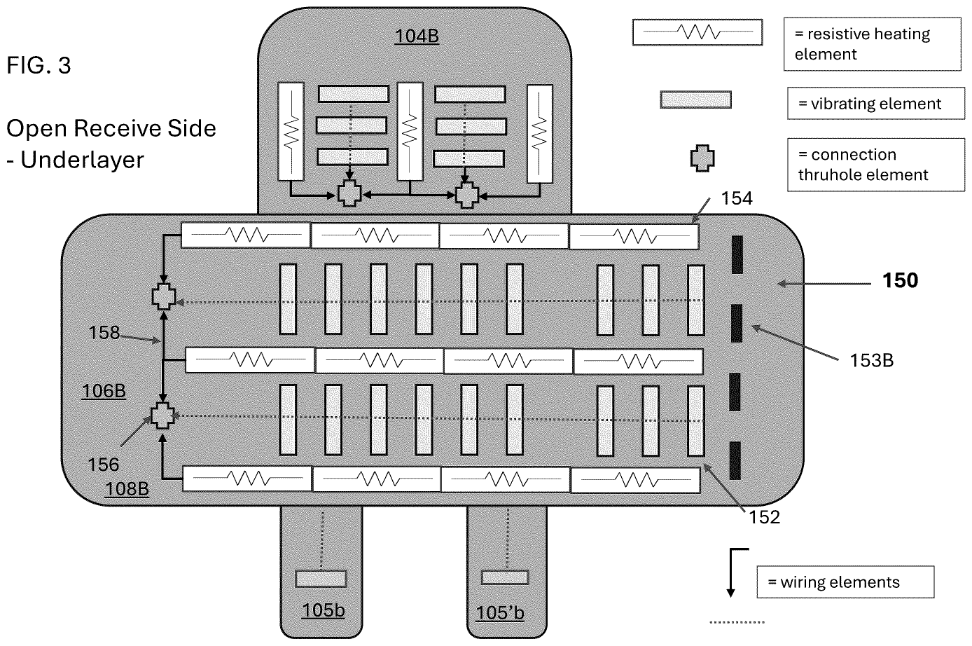

FIG. 3 shows structural and electronic elements associated with an underlayer 150, which is located under a cloth top surface of the fluid extraction wrap 100. In other words, underlayer 150 is preferably sandwiched between the distinct fabric portions of wrap 100 in regions 104, 105, 106, and 108 as structures 104B, 105b, 105′b, 106B, and 108B. Underlayer 150 may comprise a single unitary flexible structure, for example a flexible circuit board, or may be constituted from distinct electrically connected sub-regions in the different areas of the wrap. The underlayer 150 houses and includes vibrational elements 152, heating elements 154, light emitting elements 153B, wiring 156, and interconnection circuitry 158, which couples the active elements to power sources and control circuits in housing 140.

In the embodiment shown in FIG. 3, the vibration and heating elements are integrated within underlayer 150 and may be attached or affixed using any conventional method. In other words, they may be sewn or sealed into place in multiple distinct regions of the wrap to ensure broad coverage and delivery of vibrational and heat energy to multiple substantial surface areas of container 170. Preferably, the energy delivery elements (152, 154) are dispersed and arranged within wrap 100 so that when activated they are optimally positioned for delivering close contact energy to multiple large surface areas of the container sidewalls. In this manner, the amount of available energy can be efficiently delivered to the container.

Persons skilled in the art will appreciate that a large assortment of known vibrating elements 152 and heating elements 154 can be employed in embodiments of the present disclosure. To wit, the vibrating elements 152 may be numbered, shaped (planar, cylindrical, etc.) and sized to be powered by a low voltage energy source (e.g., regular batteries, rechargeable batteries, etc.). The heating elements 154 can be of a resistive type used in other conventional consumer devices, but with increased allowance of energy output since the application is not intended for contact with human skin.

As seen in FIG. 4A, to supply the power for the energy delivery elements 152/154, a DC or AC source 162 can be used, depending on the desired container form factor and energy requirements for the materials in question. For some applications involving materials with extremely high viscosity, it is possible that a conventional AC power source 168 may be necessary to supply sufficient energy. For most applications, however, battery power 164 (in the form of standard batteries or rechargeable batteries) is sufficient to provide useful results for the bulk of liquids and containers. Note that the vibrational energy need only be sufficient to cause movement of the material and accordingly is not likely to cause damage to the container.

The energy/frequency settings can be used to generate sufficient and optimal energy to the container to induce flow of liquid therein. The particular amplitude, frequency, time, etc. can be adjusted and set as well through control knobs/dials 144 using a control circuit 160 to accommodate different sized containers and different types of liquids. For example, the settings for removing mayonnaise from a plastic container may be significantly different than those used for removing mustard from a glass container. By enabling different controllable settings, material can be extracted from a wide number of consumer perishable items.

FIGS. 4A and 4B show an embodiment of a housing and control circuit that can be utilized in the present embodiments. The panel 146 of FIG. 4B depicts controls in the form of switches, dials, knobs, etc. 144 that are presented on the spine 140. In preferred embodiments, the user can alter a number of parameters of the vibration apparatus, including an amplitude (A) of the vibrations, a frequency/mode (F) of the vibrations, a time (T) for the vibrating operation, and a heat intensity (H) used by the heating elements. It will be understood that the placement of the controls, the types of controls, and their specific implementation form can be varied in accordance with any desired form factor. For example, some controls may be omitted for simplicity and cost reasons, and they may be placed in different parts of the apparatus for convenience (e.g., an on/off switch).

FIG. 4A identifies the basic components of the activator circuit that controls the vibration and heating of containers. This includes a power source (AC/DC) 162 that could be sourced from conventional AC power 168, discrete battery power 164 (e.g., batteries), and/or rechargeable batteries. In some instances, as noted below, power can be supplied by a companion device (e.g., a food processor, refrigerator) that integrates the vibration apparatus functionality. Energy is provided to the container directly through vibration elements 152 and optional heating elements 154, which may be included in the base, sleeve, cap, and/or strap structures (as discussed above). Electrical connections for supplying control and/or power to these elements can be routed through these structural components as well.

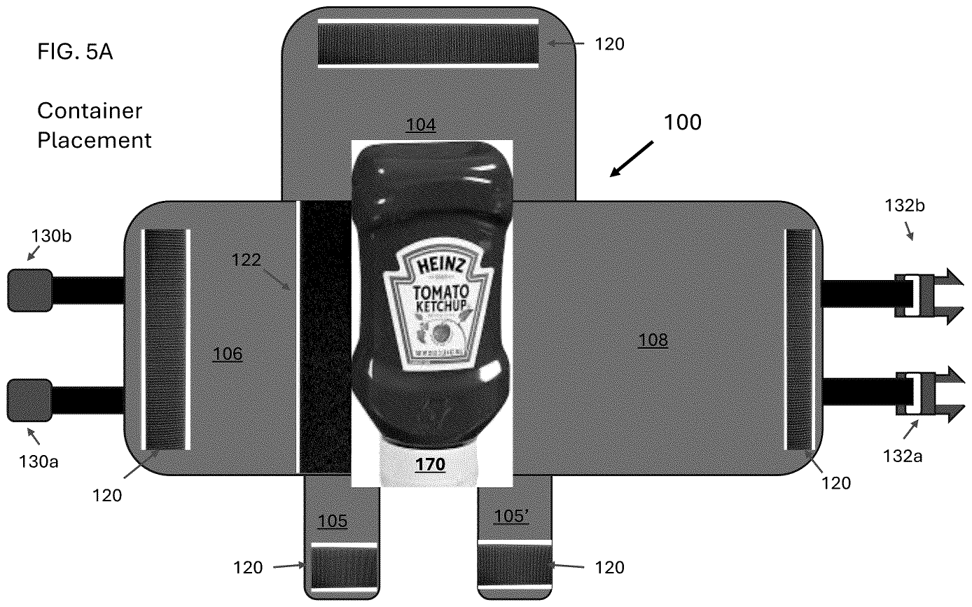

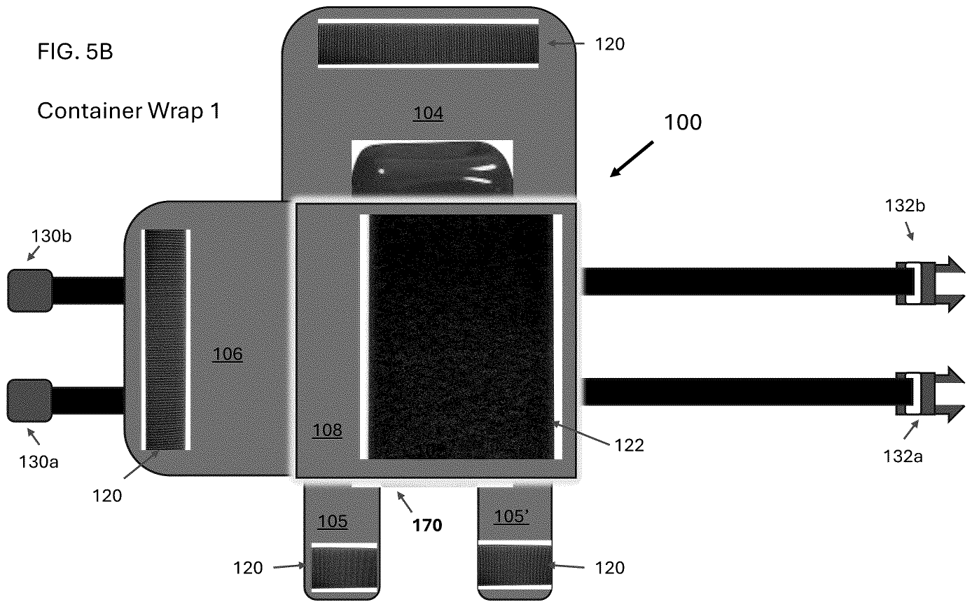

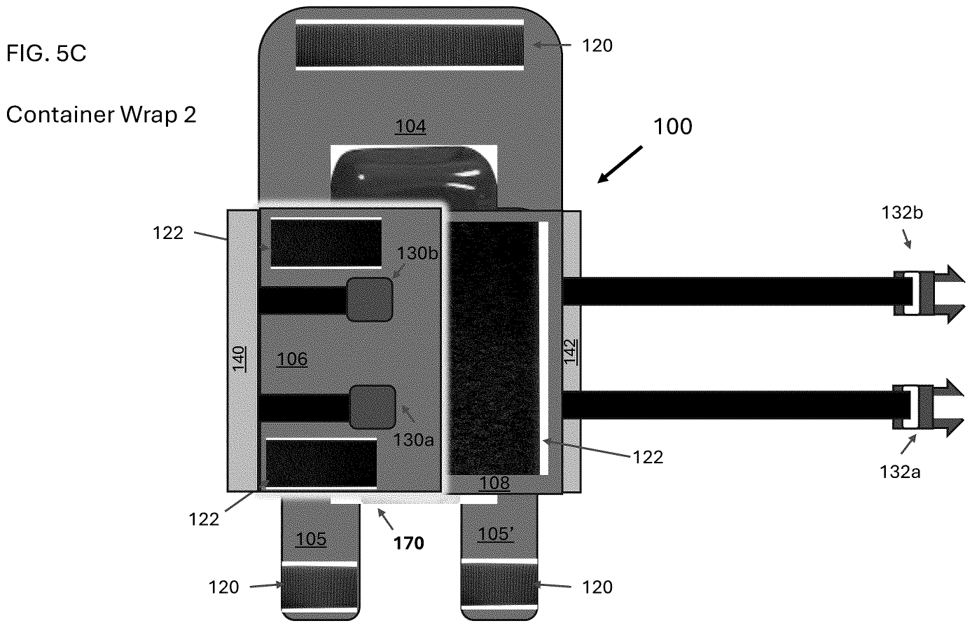

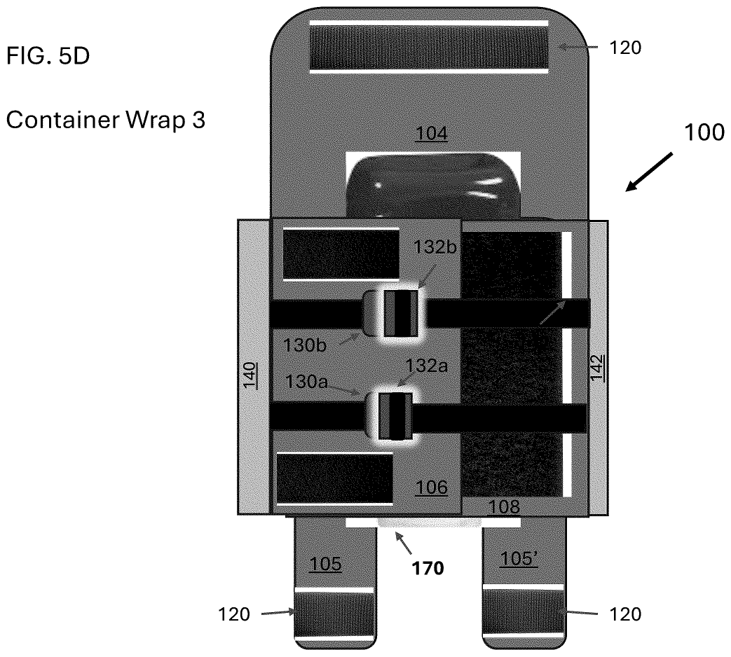

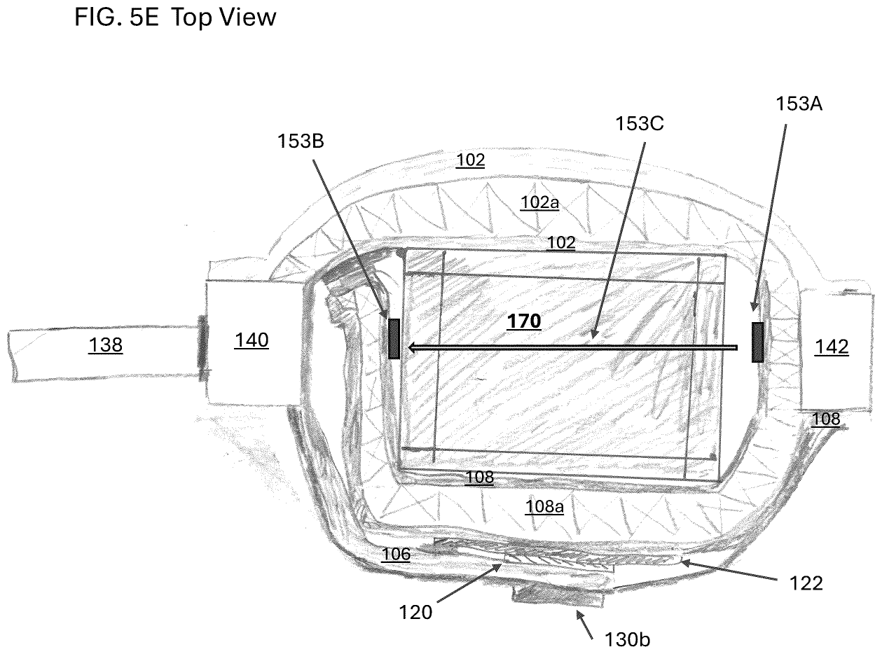

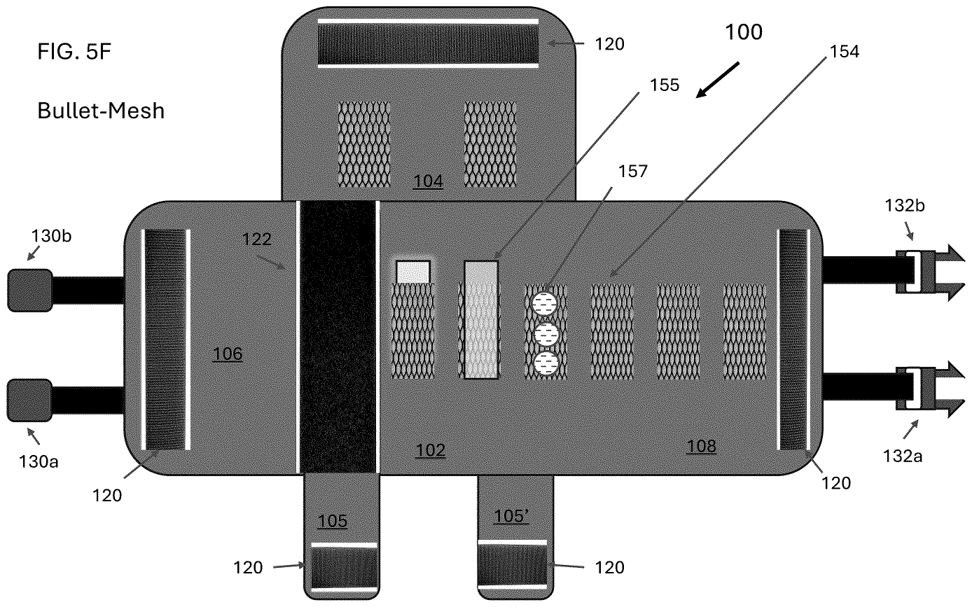

In some implementations, an automatic shut-off mode can be effectuated through an optical sensor that detects changes in the transparency of the container, as seen in FIG. 5E. A sensor/detection pair 153A, 153B is mounted on the spines 140, 142 with one active directed light source providing a reference light beam passing through the container, which is detected by a second passive detector on the opposite side. In an auto timing mode (see box 166 FIG. 4A), the intensity of the received light beam is measured at the beginning of the cycle and changes are detected over time by the controller circuit (shown in FIG. 4A). The auto shut-off mode could be implemented by circuit 166 using any number of factors, such as by noting an absolute change in light intensity over time (e.g., if the amplitude increases by a factor of X in a period T to signify the movement of material from that area) and/or by noting that the light intensity has not appreciably changed in a prior period T (to signify that no further progress can be made using the current settings). It will be appreciated that any desired range of auto operational modes can be implemented depending on the required operational requirements and cost constraints. For high value liquids where it is desirable to extract the maximum amount of material, the cost of a detector may be justified.

FIGS. 5A-5D illustrate an example of a container being wrapped and secured in preparation of movement/extraction by the flexible vibration liquid extraction apparatus. All the steps shown can be performed easily by a human operator to enable movement/removal of material in a container. All reference numbers refer to the same structures previously identified.

In FIG. 5A, the flexible vibration wrap 100 is placed on a suitable flat surface and the container 170 is placed in main body section 102, which is typically oversized to accommodate different shapes and sizes of containers. This step results in a first back surface of container 170 now making firm contact with vibration elements 152 in body section 102.

As seen in FIG. 5B, wing section 108 is then overlaid on top of container 170, from right to left, with a hook/loop 120 under the left edge of 108 engaging with a counterpart hook/loop fastening element 122 situated on a left edge of section 102 (FIG. 5A). This arrangement acts as a second region of attachment/contact for vibration elements 152 in wing portion 108 with a second front surface/sidewall of container 170.

In FIG. 5C, wing section 106 is then overlaid on top of wing section 108, from left to right, with a hook/loop 120 (FIG. 5A) now under the left edge of 106 engaging with and contacting a counterpart hook/loop fastening element 122 situated on a center/right edge of wing section 108 (FIG. 5A). This arrangement further helps to secure container 170 within the flexible vibrating wrap 100, and place fastening elements 130a, 130b into position where they can engage with counterparts 132a, 132b in a later step, as shown in FIG. 5D, where the two components can be interlocked in a conventional fashion. Additional slack in the straps can then be taken up and adjusted manually to further tighten and increase surface contact pressure between the wrap vibration elements 152 and sidewalls of container 170. The bottom tabs 105, 105′ can also be flipped upwards into position so that hook/loop structures 120 thereon contact and engage with counterpart hook/loop structures on wing portions 106 and 108. This further secures container 170 within the flexible vibration wrap 100 and ensures that it does not come loose during an activation operation mode.

FIG. 5E shows an overhead view of the vibration apparatus 100 with a container wrapped/secured 170 and made ready for a liquid extraction process. As seen there, the container 170 is sandwiched between a body section 102 and wing portions 106, 108. The flexible wrap portions (102, 106, 108) can be attached in any suitable manner to spine structures 140, 142 or to each other. Active elements (vibrational 152 and heat 154) are positioned in tight and close proximity by a combination of interoperating fastening elements (120, 122, 130b) to sidewalls of container 170 to permit ample and efficient delivery of energy to the container during an active liquid extraction/movement operation. The unit can be held by a handle 138 connected to a spine/housing 140. An optical detector pair (153A, 153B) can be optionally employed as well to detect movement and presence of material through changes in an intensity of light beam 153C.

FIG. 5F shows a variant of the flexible vibrating wrap 100 in which small vibrational elements 155 (which can be individually battery powered) and optional bearing elements 157 are incorporated with pocket elements of the wrap. The pocket elements can be comprised of elastic mesh or similar material sufficient to retain their shape and maintain contact to the container 170 in an active operating mode.

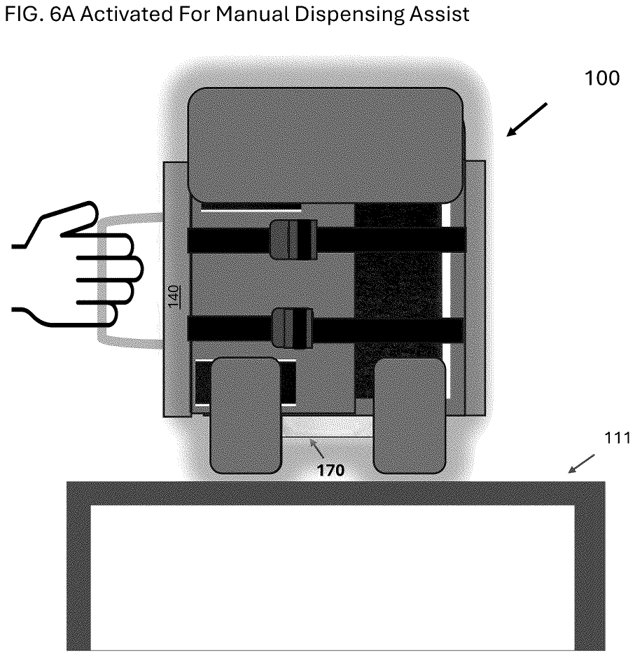

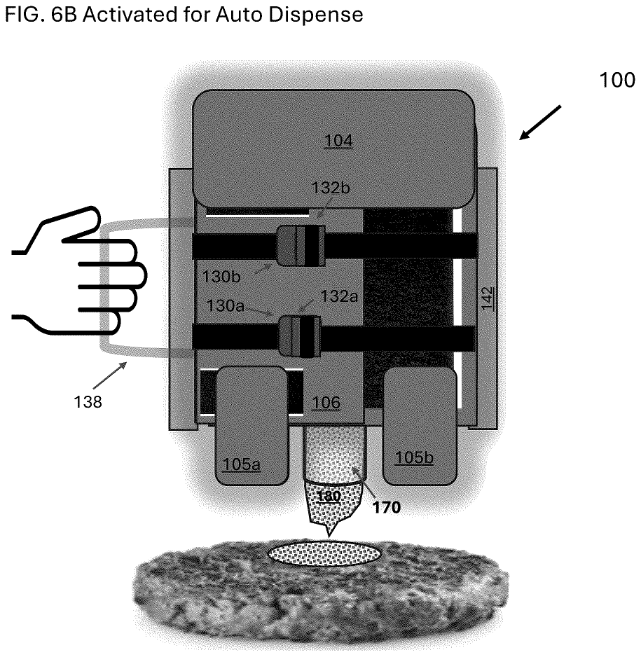

FIG. 6A shows the liquid extraction apparatus 100 in an active operational mode during which the unit is powered on to activate vibrating and/or heating elements with sufficient energy to cause material within the container 170 to be moved from a top portion to a bottom portion. As discussed above, the operating parameters for the activatable elements can be controlled as needed to achieve a desired or sufficient flow of material within most containers and for most fluids. The unit can be hand held and placed on a solid surface 111 as well during an active mode to enhance delivery of energy to the container sidewalls.

In some applications surface 111 can be integrated and implemented as a shelf or platform as part of a larger appliance, such as a refrigerator door (not shown). In such appliance-integrated applications the wrap elements 102, 104, 105, 106, 108 and strap elements 130a/132a and 132a/132b may also be attached to or part of a platform to facilitate holding a container 170 in place. The benefit of such embodiment includes the fact that the apparatus 100 can be powered directly by energy already incorporated within the appliance, and affords a convenient location for processing containers stored in a refrigerator for example.

FIG. 6B shows the liquid extraction apparatus in an active operational mode during which material within the container is controllably removed and dispensed through a bottom portion. The advantage of the disclosed apparatus includes the fact that material can be dispensed continuously and smoothly to an external target item/surface (such as a food item) using the activation elements, avoiding the need for manual shaking or uneven dispersal of the fluid to a target item/surface. In the prior art manual techniques, shaking containers often results in excessive material being expelled uncontrollably and wastefully. The nozzles and caps known in the prior art (FIG. 10C) can also be advantageously employed in combination with the present apparatus to improve dispersal of viscous materials, by attaching them to the end cap portion of the container before activating the flexible wrap vibrating apparatus.

Note that while some prior art containers are specifically designed to be left upside-down in a storage position to make dispersal of material easier (e.g., usually through pressure induced by squeezing the container) this technique suffers from the fact that the constituent materials in many food condiments (ketchup, mustard) tend to separate over time. This means that when the container is removed from a refrigerator, the first volume of material that flows is typically lower viscosity material that has separated, such as water, vinegar, etc. This alters the composition of the remaining material and often results in soggy food items as well. To counter this problem, users typically have to manually shake the containers to homogenize the material, and this has the effect of redistributing the contents in unfavorable positions along the sidewalls and necessitating again a series of manual manipulations to coax the material cleanly out of the end of the bottle/container.

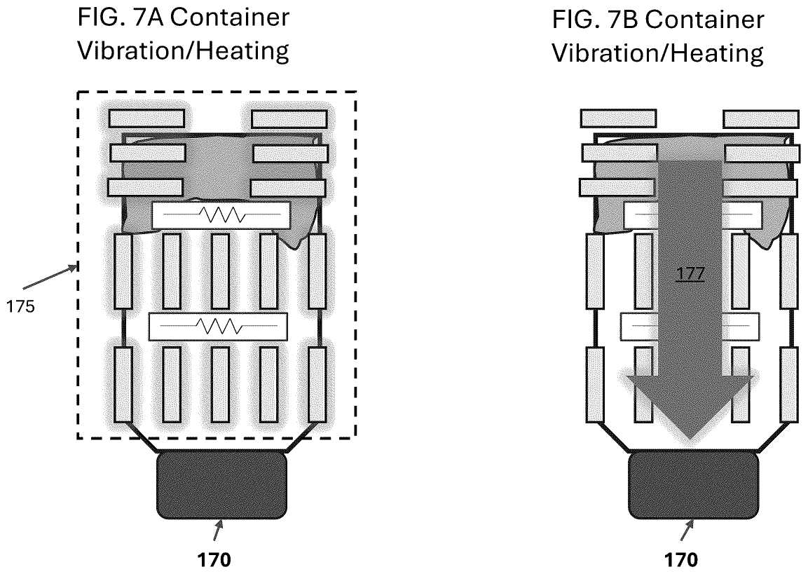

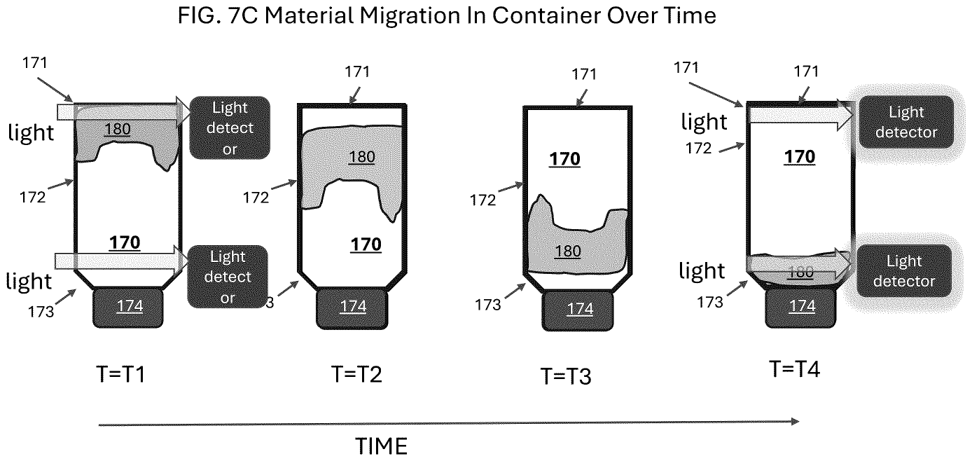

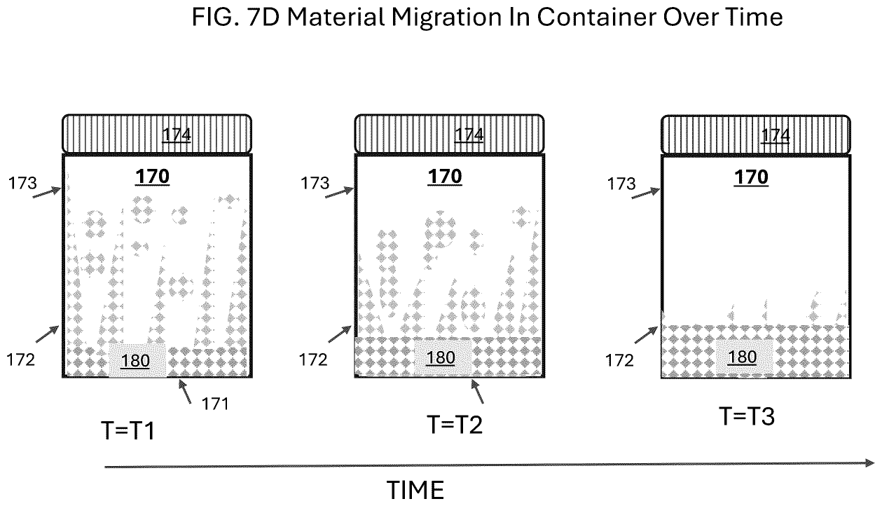

FIG. 7A shows a structural overlay of the active elements (including vibrational and optional heating elements) of the flexible wrap liquid extraction apparatus engaging with surfaces of the container during an activation mode to move material therein. The vibration elements 152 and heating elements 154 are shown isolated and activated in a cut-away cross section or plane 175 as they would be present at a surface of the sidewalls of the container 170.

FIG. 7B shows the movement of material in sidewalls of the container during an activation mode. The result of the activation process is that the material is dislodged and made free to move in the direction of the arrow 177 induced by gravity.

FIG. 7C visually depicts the migration and change of position of material 180 in a container 170 over time as effectuated by embodiments of the disclosure, and associated changes in light detection as a result thereof.

In this embodiment fluid 180 can be removed in a first time from the container using an energized activation mode that is significantly shorter than a time required for a gravity or passive treatment of the container. The volume of fluid can be removed continuously and smoothly from the container during the activation mode and without additional human supplied energy or force applied to the container.

In some implementations, an automatic shut-off mode can be effectuated through an optical sensor that detects changes in the transparency of the container, as seen in FIG. 5E. A sensor/detection pair 153A/153B are mounted on spines 140/142 with one active directed light source providing a reference light beam passing through the container, which is detected by a second passive detector on the opposite side. In an auto timing mode, the intensity of the received light beam is measured at the beginning of the cycle and changes are detected over time by the controller circuit shown in FIG. 4A. The auto shut-off mode could be implemented by any number of factors, such as by noting an absolute change in light intensity over time (e.g., if the amplitude increases by a factor of X in a period T to signify the movement of material from that area) and/or by noting that the light intensity has not appreciably changed in a prior period T (to signify that no further progress can be made using the current settings). It will be appreciated that any desired range of auto operational modes can be implemented depending on the required operational requirements and cost constraints. For high value liquids where it is desirable to extract the maximum amount of material, the cost of a detector may be justified.

This process is shown visually in FIG. 7C as well. The fluid 180 is concentrated at a bottom 171 of the container before the activation mode is enabled. Light (from a diode or similar source 153A—see FIG. 5E) is substantially blocked and attenuated so that a received amplitude or intensity at a light detector 153B (see FIG. 5E) is comparatively small. As material 180 is dislodged during a vibrational energy delivery process, it flows down sidewalls 172 to a top portion 173 and cap 174 of container 170. The light measured at T=T4 by the light detector 153B is thus higher, signifying that the material has indeed been moved from portion 171 of the container. This measurement can be used to effectuate an automated mode, which the user can simply select through the control panel and cause the apparatus to automatically shut off after the material is detected as dislodged, or some predetermined, controlled time thereafter. Other variations will be apparent to those skilled in the art; for example, multiple light sources 153A and detectors 153B may be used to measure intensity at different vertical slices or heights of the container 170. An auto shut-off mode may be used when the opposite condition occurs, namely, the amount of light changes from high to low in a top section 173 of container 170.

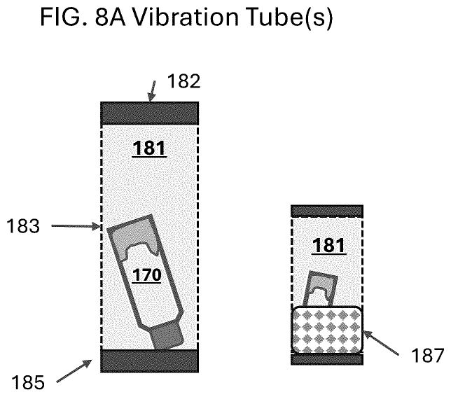

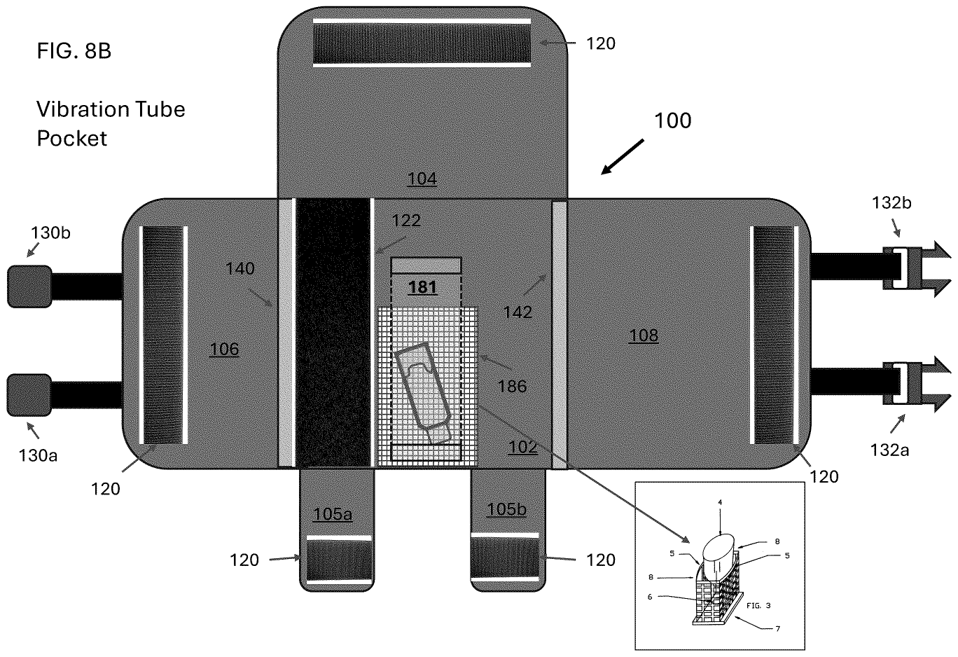

FIGS. 8A-8B show an optional vibration tube and pocket that can be incorporated within the flexible vibration wrap for securing and treating smaller container items. A vibration tube 181 is shaped and sized to accommodate typical smaller household items, such as shampoo bottles, lotion bottles, etc. These materials are typically sold in smaller containers and may be too small to be gripped securely within the wrap features of apparatus 100. The vibration tube 181 includes a smaller enclosed volume to allow for a small container 170 to be placed therein and given similar treatment. The tube 181 includes a cap 182, a bottom 185, and sidewalls 183. A smaller container 170 can be placed therein. Thereafter, as seen in FIG. 8B, the vibration tube 181 can be placed directly into a pocket structure 186 in apparatus 100 so that it can be treated with vibrational and heat energy as well. The pocket can have any suitable form and composition to permit delivery of energy to the vibration tube 181 from the wrap 100 vibration elements 152 and heating elements 154. As further seen in FIG. 8A, to enhance delivery of energy to the smaller container 170 within tube 181, a filler material 187, such as a volume of individual small metallic or glass bearings (in the form of spheres or some other convenient shape), can be included within the tube to fill to some predetermined level. The container 170 can then be wedged into this mix for treatment, and surrounded by the individual energy delivery enhancement elements 187 to increase contact area and transfer of the wrap 100 vibrational energy.

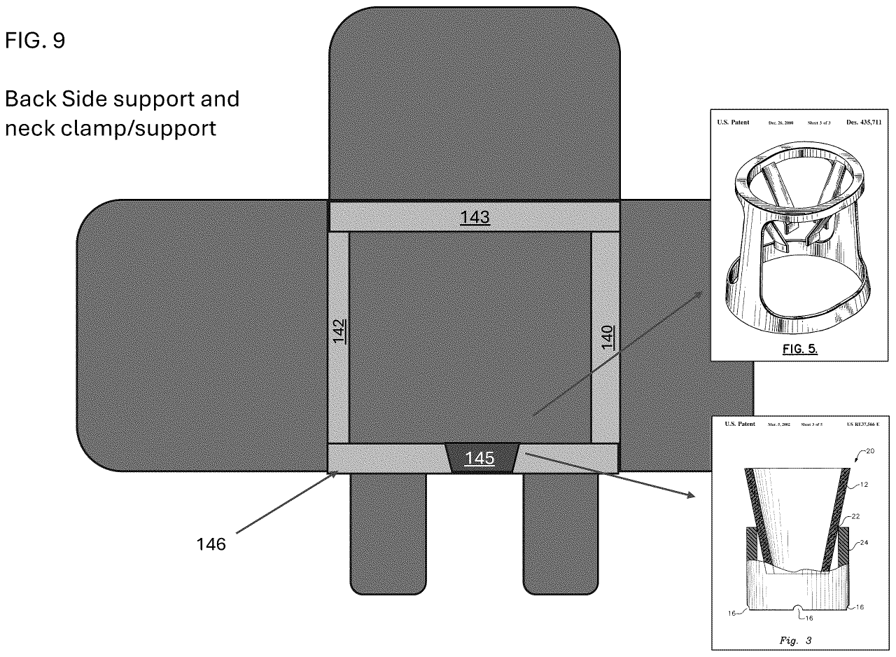

FIG. 9 shows an optional support structure 143 for providing rigidness to the body of the wrap 100, with an integrated container neck receptacle functionality 145. The latter structure 145 can be in a shape, size and composition as shown in the referenced US patents RE37,566 and DES 435711, excerpts of which are shown in FIG. 9 and incorporated by reference herein. Support structure 143 preferably includes dual top and bottom lateral members spanning between spindle 140 and spindle 142. The resulting frame 146 can be implemented in some embodiments where additional structural support is desired for applications involving relatively heavier containers.

The end result of a vibration process, as shown in FIG. 7C, is that the material 180 is dislodged and collects in the neck 173 or cap 174 of the container 170 where it can be more conveniently removed or retrieved. In some instances, the containers are already adapted to use pressure to expel the contents and therefore the invention facilitates this process by concentrating the material in the most useful region of the container. In some applications, the prior art caps or attachments (see FIG. 10C) can be employed to further increase the ease and amount of material removed. That is, the apparatus 100 of the present invention can bring about a more rapid and complete distribution of the material to the end of the container where it can be efficiently removed using one of these prior art devices.

Note that the embodiment disclosed herein is superior to the prior art techniques, including 1) passive gravity approaches (which take too long and are not forceful enough for some materials); 2) manual force (which is inefficient, uncontrolled and simply spreads the material around in the container); and 3) fitted attachments (see FIG. 10C), which similarly rely solely on manual force or passive gravity. The benefits of using low-power active vibrational energy include faster, more effective movement of the fluid into a region of the container where it can be more easily and efficiently removed on a comparative volume basis. In other words, embodiments of the invention allow for a recovery of a greater amount of existing volume of material present in the container.

In addition, resistive heating elements can be incorporated as well in other areas of the inflatable bladder, so that they too are brought into contact with the sidewalls of the container. In this position, they can deliver any desired amount of heat energy to the sidewalls, increasing the temperature slightly at the container/liquid interface, and thus reducing the viscosity, causing the material to flow more easily. The resistive heating elements can be powered by the same source used for the vibrating elements and the pneumatic pump. As alluded to earlier, the amount/intensity of heating used can be controlled (through a dial, knob, etc.) and tailored to the material being removed to achieve the desired result.

It will be understood by those skilled in the art that the above descriptions are merely examples and that countless variations of the invention can be implemented in accordance with the present teachings. A number of other conventional structures that would be included in a commercial product have been omitted, as well, to better emphasize the present teachings. It is understood that the protection afforded the present invention also comprehends and extends to embodiments different from those above, but which fall within the scope of the claims presented below.

What is claimed is:

1. An apparatus for assisting movement of a volume of fluid within a solid container, which container has a first bottom end and a second top end comprising:
a. a flexible energy delivery wrap including:
i. a first body section adapted to hold one or more vibration elements, which vibration elements are activatable by electric energy;
wherein at least a first body surface of said body portion is adapted to make contact with the solid container and position said vibration elements in proximity to a first container surface;
ii. one or more second foldable wing sections, attached or attachable to said first body section, and adapted to be positioned in proximity to and cover at least a portion of a second container surface so as to secure the first container surface in proximity to said vibration elements;
iii. one or more fastening elements attached to either or both said first body section and said one or more flexible wing sections, said one or more fastening elements being adapted to assist in maintaining said solid container positioned between said first body section and said one or more flexible wing sections;
iv. an electrical control circuit coupled to the vibration elements and adapted to provide a power source sufficient to activate said vibration elements;
wherein the apparatus includes an activation mode enabled by electrical power, during which activation mode the apparatus can apply sufficient vibrational energy to the container through at least the first container surface to assist and facilitate movement of the volume of fluid from a first bottom end of the container to a second top end of the container.

2. The apparatus of claim 1, further including heating elements incorporated within at least one of said first body section and said one or more flexible wing sections adapted to heat a surface of the solid container.

3. The apparatus of claim 1, wherein said electrical control circuit is adapted to control at least one of an amplitude and frequency of vibrations generated by said one or more vibration elements.

4. The apparatus of claim 1, wherein the volume of fluid can be removed in a first time from the container using said activation mode that is shorter than a second time required for a gravity or passive treatment of the container.

5. The apparatus of claim 1, wherein the volume of fluid can be removed continuously and smoothly from the container during said activation mode.

6. The apparatus of claim 1, wherein substantially all of the volume of fluid can be removed from the container during said activation mode without additional human supplied energy or force applied to the container.

7. The apparatus of claim 1, wherein the first body section is comprised of three separate layers forming a sandwich structure, including: 1) a first top fabric layer for making direct contact with said first container surface; 2) a second middle interlayer with a first side under said first fabric layer for holding said one or more vibration elements; and 3) a third fabric layer for covering a second side of said second middle interlayer; wherein the vibration elements are secured and positioned in a substantially fixed position on said first body section.

8. The apparatus of claim 1, wherein the one or more flexible wing sections also include a second separate set of vibration elements.

9. The apparatus of claim 8, wherein the second separate set of vibration elements can be maintained in close proximity to a second container surface by one or more horizontal fastening wing elements running in a horizontal direction relative to the solid container.

10. The apparatus of claim 8, wherein the second separate set of vibration elements can be maintained in close proximity to the first bottom end of the container by one or more vertical fastening wing elements running in a vertical direction relative to the solid container.

11. The apparatus of claim 1, wherein the one or more second flexible wing sections are located on opposite vertical edges of the flexible wrap relative to said first body section and are foldable horizontally over a first surface of the solid container.

12. The apparatus of claim 1, further including one or more tabs located at a bottom edge of the flexible wrap and adapted for securing the solid container from moving in a vertical direction when it is placed in the flexible wrap.

13. The apparatus of claim 1, wherein the one or more second flexible wing sections include a top section situated on a top horizontal edge of the flexible wrap relative to said first body section and is foldable vertically over a first surface of the solid container.

14. The apparatus of claim 1, wherein said one or more second flexible wing sections are attachable to said first body section using hook and loop attachment elements.

15. The apparatus of claim 1, further including at least one rigid spindle structure attached to said first body section and adapted to house said electrical control circuit.

16. The apparatus of claim 1, further including a rigid support structure with a top member connected to said at least one rigid spindle structure and a second bottom member adapted with a recess for receiving and holding the second top end of the container.

17. The apparatus of claim 16, wherein said rigid support structure includes an integrated support for a neck of said container and an extraction cap.

18. The apparatus of claim 1, wherein the fastening elements include a clip, straps, and/or a cinchable for securing the container to the sleeve.

19. The apparatus of claim 1, further including solid bearing elements incorporated within the energy delivery wrap to deliver vibrational energy to the container.

20. The apparatus of claim 1, wherein said energy delivery wrap includes at least two separate sets of vibrational elements.

21. The apparatus of claim 20, wherein said at least two separate sets of vibrational elements include a first set in said first body portion in close proximity to a first surface of the solid container and a second set in close proximity to a second surface of the second container and situated in said one or more wing sections.

22. The apparatus of claim 1, further including an optical sensor detector incorporated into the energy delivery wrap for determining a presence and/or quantity of liquid in a cross section of the container.

23. The apparatus of claim 22, further including an automated activation mode that has a duration based on said optical sensor detecting a change in a quantity of said liquid and discontinues said activation mode based on said change reaching a controllable threshold.

24. The apparatus of claim 1, further including: a separate vibration container for housing a small container; a pocket in said flexible wrap being adapted for holding the vibration container.

25. The apparatus of claim 7, wherein said second middle interlayer includes a flexible printed circuit board for interconnecting said vibrational elements to said electrical control circuit.

26. The apparatus of claim 1, further including a handle attached to said flexible energy wrap sized and shaped for permitting an operator to hold the apparatus in their hand during said activation mode and dispense said fluid smoothly and continuously through an integrated extraction cap attached to the solid container.

27. The apparatus of claim 1, wherein the solid container can be placed in an opposite orientation in the wrap so as to cause movement and compaction of said fluid in a first bottom end of the container.

28. The apparatus of claim 1, wherein the flexible energy delivery wrap is integrated and incorporated within a large appliance, and is powered by an energy source included within such appliance.

29. A method for extracting viscous material from a container, the method comprising:
a.) wrapping a form-fitting sleeve around the exterior of a cylindrical container, wherein the sleeve comprises integrated vibrating and heating elements;
b.) activating the vibrating elements to induce mechanical vibrations in the container, thereby decreasing the viscosity of the material within the container by increasing the kinetic energy of the fluid molecules;
c.) simultaneously activating the heating elements to apply localized heat to the container's surface, further reducing the viscosity of the material by increasing the temperature;
d.) continuously or intermittently adjusting the vibration frequency and heat intensity based on the container size and material viscosity to optimize the flow of the material from the container; and
e.) dispensing the material from the container by either manually tilting the container or utilizing an automatic dispensing mechanism integrated with the sleeve.

30. An apparatus comprising:
a form-fitting sleeve configured to wrap around the exterior of a cylindrical container, the sleeve comprising:
a.) integrated vibrating elements positioned to apply mechanical vibrations uniformly to the container when activated;
b.) integrated heating elements positioned to apply localized heat to the container's surface when activated;
c.) a control unit configured to adjust the frequency of the vibrating elements and the intensity of the heating elements based on the container size and material viscosity;
d.) a power source connected to the vibrating and heating elements, the power source being one of a battery or an AC power supply;
e.) a securing mechanism, such as Velcro or straps, to hold the sleeve in place around the container during operation; and
f.) an optional manual or automatic dispensing mechanism that facilitates the flow of material from the container when the viscosity is sufficiently reduced.
